(19) United States
(12) Patent Application Publication
(10) Pub. No.: US 2010/0146065 A1
(43) Pub. Date: Jun. 10, 2010

(54) METHOD AND APPARATUS FOR REALIZING INSTANT MESSAGING BETWEEN A PLURALITY OF MEMBERS IN AN INSTANT MESSENGER GROUP

(75) Inventors: Pinpin Zhu, Shanghai (CN); Bo Li, Shanghai (CN); Hui Yuan, Shanghai (CN)

Correspondence Address: HAVERSTOCK & OWENS LLP, 162 N WOLFE ROAD, SUNNYVALE, CA, 94086, US

(73) Assignee: INCESOFT CO., LTD., Shanghai (CN)

(21) Appl. No.: 12/630,649

(22) Filed: Dec. 3, 2009

(30) Foreign Application Priority Data
Dec. 4, 2008 (CN) 200810204067.1

(51) Int. Cl. G06F 15/16

(52) U.S. Cl. 709/206

(57) ABSTRACT

The invention provides a technical solution for instant messaging among multiple members of an instant messenger group. An instant messenger group server is independent of an instant messenger server. At least one group identification and a member list of each group identified by the corresponding group identification are prestored in the group server. The instant messenger group server logs in to the instant messenger server as an instant messenger client, using each of said at least one group identification as an instant messenger identification, and receives instant messages sent by an instant messenger client and sends the instant messages respectively to each of the instant messenger clients corresponding to the instant messenger identifications of other members the instant messenger server. Since the instant messenger group server is independent of the instant messenger server, the instant messenger group server can support multiple instant messenger platforms.

### TECHNICAL FIELD

The invention relates to the instant messaging technology and particularly to the instant messenger group technology.

### BACKGROUND OF THE INVENTION

Along with the development of the Internet and the popularization of the personal computer, instant messenger services are also widely used. The identification (ID) of network instant messenger services has gradually become the unique identity identification of large amount of net friends. A user of the instant messenger can add other users with whom he is often in contact to a friend (or contactor) list, get the on-line/off-line state of his friends through the status presented in the instant messenger and initiate a real-time conversation with them at any time, so that the purpose of an instant communication is achieved. Large amount of net friends are used to logging in to instant messenger servers as soon as they turn on their computers so as to keep in contact with his friends at any time.

To meet users' diversified demands, besides ordinary one-to-one communication through the instant messenger; instant messenger software also provides communications among multiple members, e.g. a multiple members' conversation via MSN (instant messenger software provided by Microsoft). However, the shortcoming of multiple members' conversation lies in that it can not keep sustained. When a user closes the conversation window, he immediately quits this conversation. If the user wants to initiate a conversation again with the same members, he has to invite them to the conversation one by one again.

In order to solve the problem of the multiple members' conversation, there is a solution in the prior art as follows: mapping a group of members into an operation object through a single identification to perform a uniform management and form a relatively fixed group; with logical operations on servers, a user identifies a group of members through a unique instant messenger identification and realize a communication with them. The essence of the solution is that an instant messenger server and an instant messenger group server are based on the same development platform, and for the instant messenger server, the group identification is not an ordinary user identification but a specific group identification.

### SUMMARY OF THE INVENTION

In view of the drawbacks of the background technology, the present invention provides a technical solution of instant messaging among multiple members in an instant messenger group. By providing an instant messenger group server independent of an instant messenger server, the function of the instant messenger group is achieved.

According to an embodiment of the present invention, a method is provided for realizing instant messaging among multiple members of an instant messenger group by an instant messenger group server, wherein said group server is independent of an instant messenger server, at least one group identification and a member list of each group identified by the corresponding group identification are prestored in said group server, each member list stores instant messenger identifications of members of the group identified by the corresponding group identification; and for said instant messenger server, the instant messenger user identified by a group identification is in friend relationship with each member of the group identified by the group identification; and the method comprises the steps of: a. automatically logging in to said instant messenger server as an instant messenger client, using each of said at least one group identification as an instant messenger identification; b. receiving an instant message sent by an instant messenger client and forwarded by said instant messenger server, said instant message comprising an instant messenger identification corresponding to said instant messenger client and a group identification of the group which the member identified by said instant messenger identification belongs to; c. determining the instant messenger identifications of other members of the group identified by said group identification according to said instant messenger identification and said group identification contained in said instant message; d. sending said instant message respectively to each of the instant messenger clients corresponding to said instant messenger identifications of other members via said instant messenger server.

According to another embodiment of the present invention, a group messenger apparatus is provided for realizing instant messaging among multiple members of an instant messenger group on an instant messenger group server, wherein said group server is independent of an instant messenger server, at least one group identification and a member list of each group identified by the corresponding group identification are prestored in said group server, each member list stores instant messenger identifications of members of the group identified by the corresponding group identification; and for said instant messenger server, the instant messenger user identified by a group identification is in friend relationship with each member of the group identified by the group identification; and the group messaging apparatus comprises an automatic login means, a receiving means, a first determining means and a sending means, wherein said automatic login means is configured to make the instant messenger group server log in to said instant messenger server as an instant messenger client by using each of said at least one group identification as an instant messenger identification; said receiving means is configured to receive an instant message sent by an instant messenger client and forwarded by said messenger server, said instant message containing an instant messenger identification corresponding to said instant messenger client and a group identification of the group which the member identified by said instant messenger identification belongs to; said first determining means is configured to determine the instant messenger identifications of other members of the group identified by said group identification according to said instant messenger identification and said group identification contained in said instant message; and said sending means is configured to send said instant message respectively to each of the instant messenger clients corresponding to said instant messenger identifications of other members via said instant messenger server.

With the instant messenger group technology of the present invention, the instant messenger group server can be independent of the instant messenger server and can provide instant messenger group services for instant messenger users, so that the implementation of the instant messenger group technology becomes simpler and more convenient; since the instant messenger group server is independent of the instant messenger server, the instant messenger group server can support multiple instant messenger platforms, which makes the implementation of the instant messenger group technology simpler and more efficient.

### BRIEF DESCRIPTION OF THE FIGURES

Other objects, features and merits of the present invention will be more apparent and prominent with respect to the following description of the non-limiting embodiments in conjunction with the accompanying figures.

FIG. 1 is a schematic diagram of a network topology structure according to an embodiment of the present invention;

FIG. 2 is a flowchart of the process of creating a group according to an embodiment of the present invention;

FIG. 3 (a) to FIG. 3(c) are schematic diagrams of the process of creating a MSN group according to an embodiment of the present invention;

FIG. 4 is a schematic diagram of the process of creating a MSN group according to another embodiment of the present invention;

FIG. 5 is a flowchart of adding users to an instant messenger group according to another embodiment of the present invention;

FIG. 6 (a) to FIG. 6 (b) are schematic diagrams of adding users to an instant messenger group according to another embodiment of the present invention;

FIG. 7 is a flowchart of the transfer process of an instant message in an instant messenger group according to another embodiment of the present invention;

FIG. 8 (a) to FIG. 8 (d) are schematic diagrams of a conversation window of an instant messenger client when the instant message indicates a preset operation instruction according to an embodiment of the present invention;

FIG. 9 is a structural block diagram of a group messenger apparatus 900 according to an embodiment of the present invention.

Wherein same or similar reference signs denote same or similar steps features/means (modules).

### DETAILED DESCRIPTION OF EMBODIMENTS

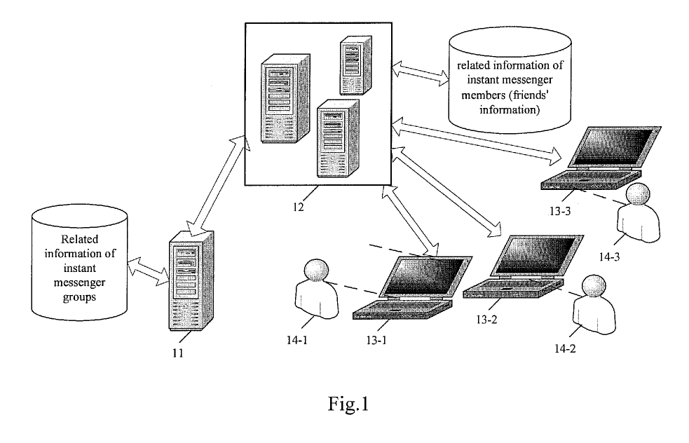

FIG. 1 illustrates a schematic diagram of a network topology structure according to an embodiment of the present invention. In FIG. 1, there are an instant messenger group server 11, an instant messenger server 12, multiple clients 13-1, 13-2 and 13-3 and corresponding users 14-1, 14-2 and 14-3, wherein the function of the instant messenger server 12 can be fulfilled by one or more tangible servers. Related information 121 of each instant messenger member including their friends' information is prestored in the instant messenger server 12. For example, for MSN, user related information, e.g. identifications and passwords of each MSN user, and contactor lists of each MSN user, in which information like friends' MSN identifications corresponding to the MSN user is stored, are prestored in the MSN instant messenger server. All the instant messenger group related information 111 including information like identifications of instant messenger groups and member identifications of the instant messenger group identified by each identification etc. is prestored in the instant messenger group server 11.

The solution of implementing the instant messaging among multiple members in an instant messenger group comprises several major processes including the creation process of the group, the process of joining the group, instant message forwarding process in the group, the process of inquiring the group, the process of quitting the group, etc.

In the following part, these major processes will be described one by one with reference to the accompanying figures.

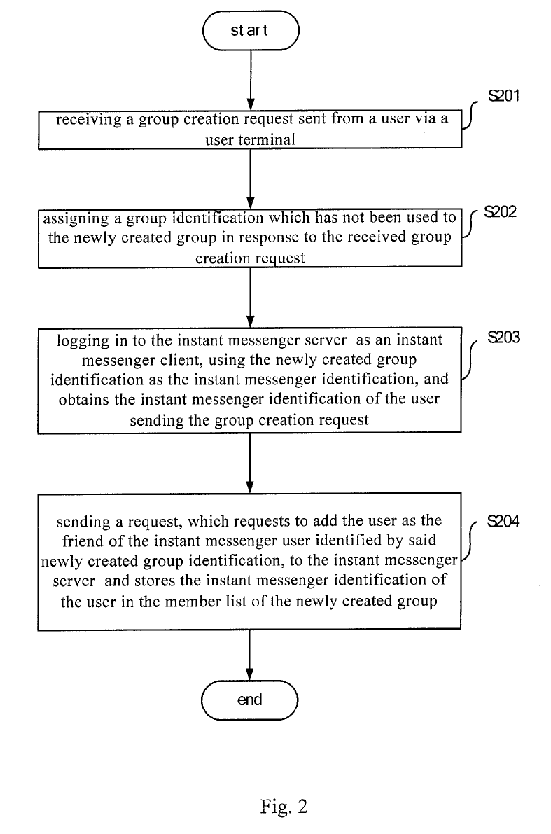

FIG. 2 illustrates a flowchart of the creation process of a group according to an embodiment of the present invention.

At first, in step S201, the instant messenger group server 11 receives a group creation request sent by the user 14-1 via a user terminal.

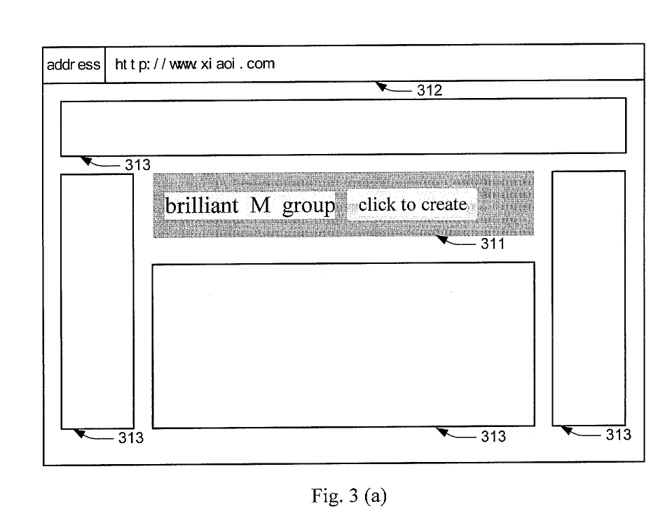

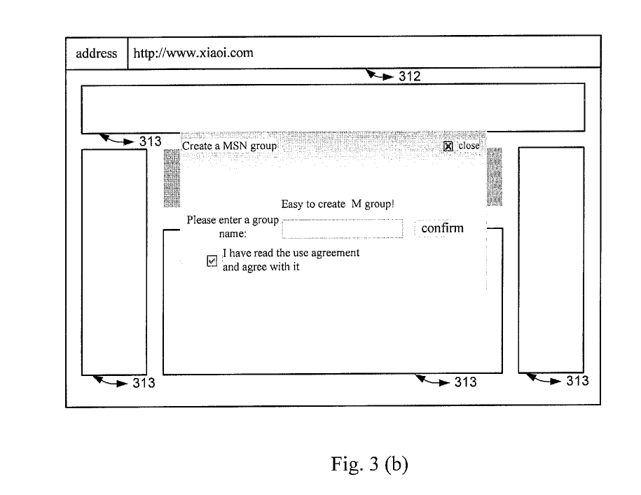

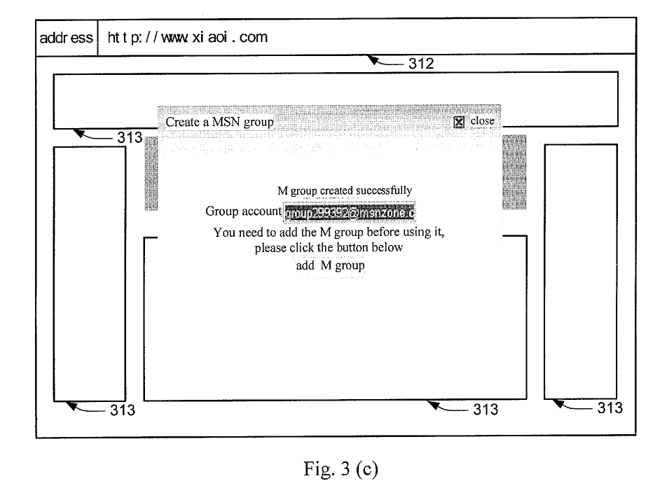

The user 14-1 can send a group creation request message via a user terminal in various ways. For example, the user 14-1 sends a group creation request via a user terminal by means of a web browser and a simple example is illustrated in FIG. 3 (a) to FIG. 3 (c). The user 14-1 only needs to open the web page as shown in FIG. 3 (a) through a web browser and click the button 311 “click to create” shown on the web page, and then a group creation request is sent to the instant messenger group server 11. For simplicity, FIG. 3 (a) to FIG. 3 (b) are only schematic diagrams, wherein 312 is the address bar and 313 is other contents of the page.

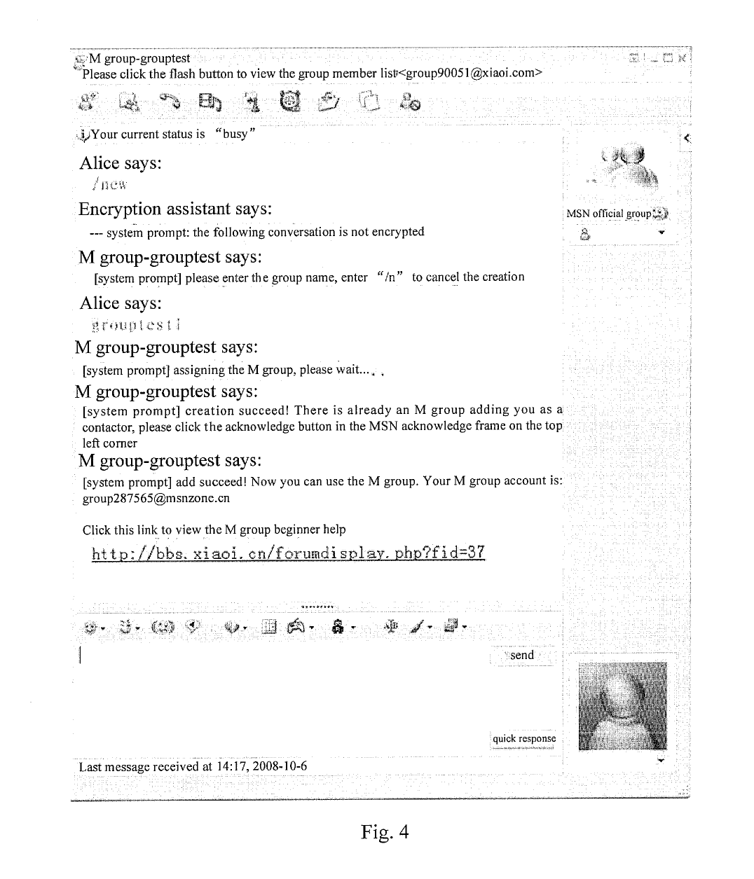

For another example, the user 14-1 can send a group creation request via the user terminal 13-1 by the instant messenger client. The group creation request contains the instant messenger identification corresponding to the user 14-1 sending the request. That is to say, users who have already used the group can input a command indicating to create a new group in the dialogue window of the group. An example for such case is illustrated in FIG. 4. The case as shown in FIG. 4 takes the MSN group as an example. A user inputs a group creation command, e.g. “/new”, in the dialogue window of the MSN group in which the user has joined and clicks the “send” button, namely sending a group creation request to the instant messenger group server 11.

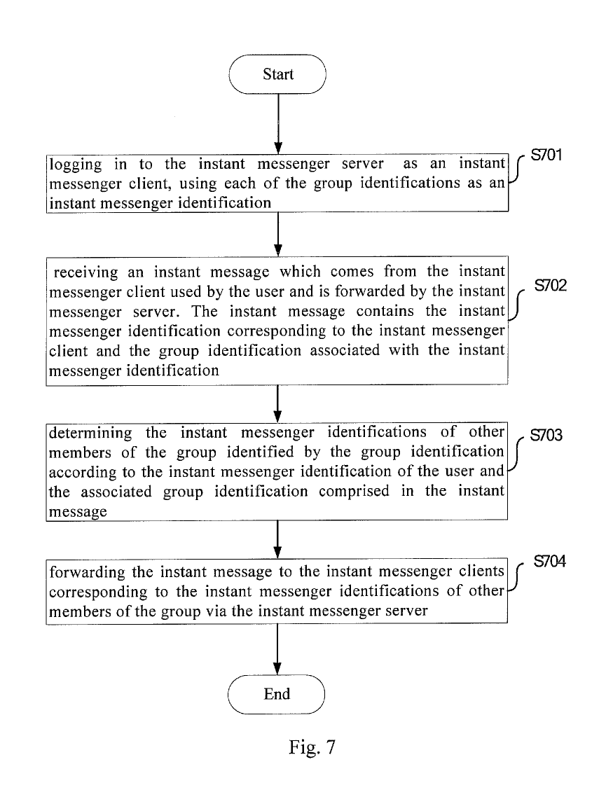

It should be noted that the transfer process of the above mentioned group creation request sent by the user 14-1 through the instant messenger client will be further elaborated in conjunction with FIG. 7 hereinafter.

Returning back to FIG. 2, after step S201, in step S202, the instant messenger group server 11 assigns a group identification which has not been used to the newly created group in response to the received group creation request in step S201.

Preferably, in some cases, before step S202, the instant messenger group server 11 can also ask the user 14-1 to input the name of the instant messenger group, as shown in FIG. 3 (b), and then execute step S202.

After that, in step S203, the instant messenger group server 11 logs in to the instant messenger server 12 as an instant messenger client, using the newly created group identification as the instant messenger identification, and obtains the instant messenger identification of the user 14-1 sending the group creation request.

It should be noted that there are various ways for the instant messenger group server 11 to obtain the instant messenger identification of the user 14-1 sending the group creation request, depending on the ways of sending the group creation request by the user 14-1.

If the user 14-1 sends the group creation request via the user terminal by means of the web browser, the instant messenger server 11 obtains the instant messenger identification of the user 14-1 by indicating the user 14-1 to accept the invitation from the user, identified by the newly created group identification, to add the user 14-1 as a friend, as shown in FIG. 3 (c). After a user has clicked the button “add M group” shown in FIG. 3 (c), the instant messenger group server 11 starts the instant messenger client software of the user terminal 13-1 used by the user 14-1 and indicates the user 14-1 to log in to obtain the instant messenger identification corresponding to the user 14-1. If the user 14-1 has logged in the instant messenger server 12 through the instant messenger client software, then the instant messenger server 11 obtains the instant messenger identification of the user 14-1 directly from the user terminal 13-1.

If the user 14-1 sends the group creation request through the instant messenger client software in step S201, then this group creation request contains the instant messenger identification corresponding to the user 14-1 and the instant messenger server 11 extracts the instant messenger identification of the user 14-1 from the group creation request.

Finally, in step S204, according to the instant messenger identification, obtained in step S203, of the user 14-1 sending the group creation request, the instant messenger group server 11 sends a request, which requests to add the user as the friend of the instant messenger user identified by said newly created group identification, to the instant messenger server 12 and stores the instant messenger identification of the user 14-1 in the member list of the newly created group.

In some cases, if the user 14-1 sets that other members are allowed to add him as a friend only after the identity verification, then the instant messenger server 12 also needs to send a verification request to the instant messenger client used by the user 14-1. Only after the instant messenger client has sent the verification response to the instant messenger server 12, the instant messenger server 12 adds the instant messenger identification corresponding to the user 14-1 in the friend list of the newly created group.

Above, the creation process of the instant messenger group has been elaborated in conjunction with FIG. 2 to FIG. 4. The process of a user joining an instant messenger group will be described in detail hereinafter.

There are at least two ways of a user joining an instant messenger group: the first way is that a user sends a join request through an instant messenger client; the second way is that the administrator or the group master of the instant messenger group sends a preset operation instruction in the group dialogue window.

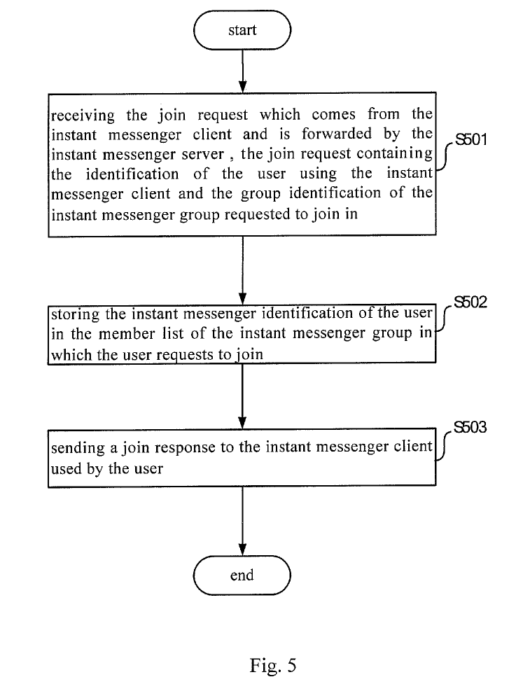

In the following part, the first way will be described in detail in conjunction with FIG. 1 and FIG. 5.

At first, in step S501, the instant messenger group server 11 receives the join request which comes from the instant messenger client and is forwarded by the instant messenger server 12. The join request contains the identification of the user 14-2 using the instant messenger client and the group identification of the instant messenger group to join. Of course, the user 14-2 can obtain the instant messenger group identification of the group, which the user 14-2 requests to join, by other means, e.g. the user 13-1 identified by the group identification informs the user 14-2 of the instant messenger group identification directly or indirectly.

Then, in step S502, the instant messenger server 11 stores the instant messenger identification of the user 14-2 in the member list of the instant messenger group which the user 14-2 requests to join.

Finally, in step S503, the instant messenger group server 11 sends a join response to the instant messenger client used by the user 14-2.

Preferably, in some cases, the instant messenger group server 11 also determines whether the user identified by the instant messenger identification contained in the join request received in step S501 is authorized to join said instant messenger group. Specifically, the above determining process can be carried out by performing an identity verification of the user requesting to join or asking the user to answer some questions.

For MSN's instant messenger users, the steps S501 to S503 shown in FIG. 5 can be performed by adding contactors. In this case, for the users or the instant messenger server 12, the instant messenger group identification is an ordinary MSN instant messenger identification.

The first way to join a group has been described hereinabove, and the second way will be described hereinafter.

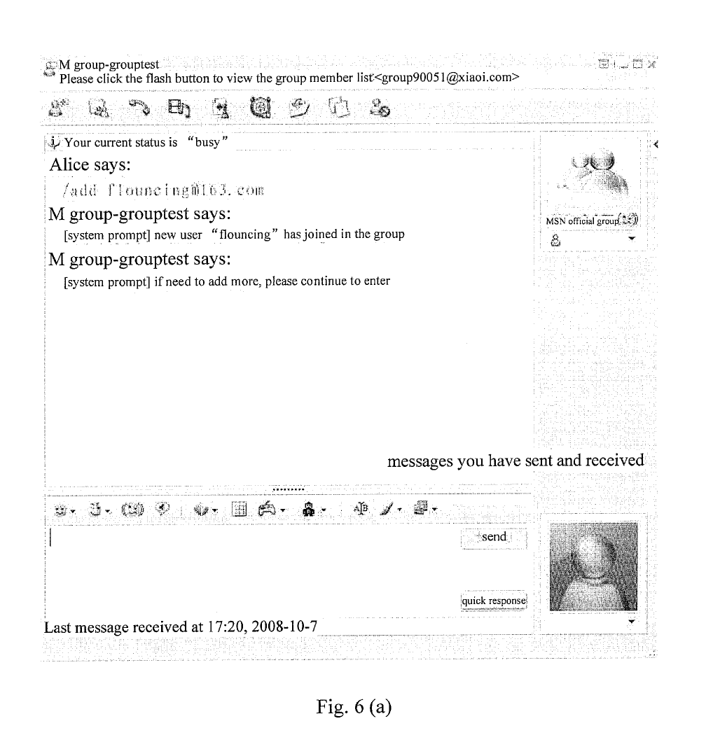

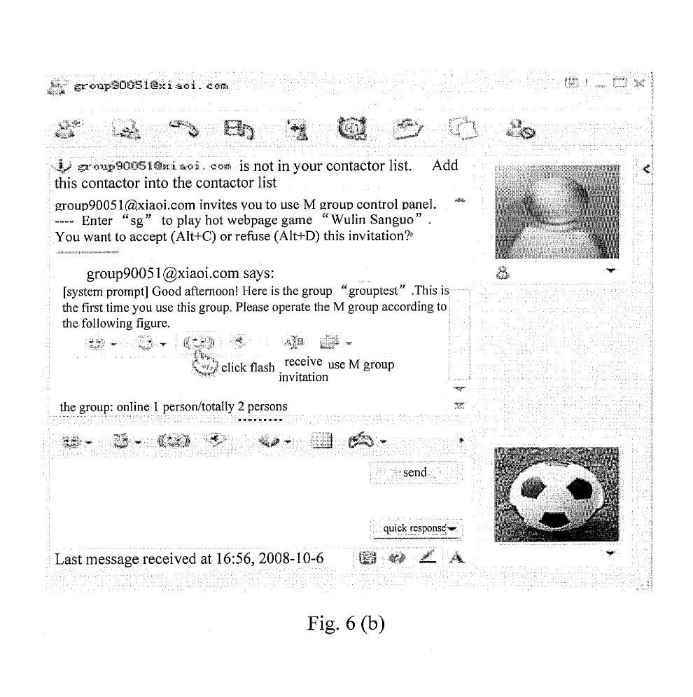

The administrator or the master of the instant messenger group can send an operation instruction indicating to add new users to the current instant messenger group in the group dialogue window, e.g. “/add instant messenger identification” to fulfill the function of adding a new user into the instant messenger group, as shown in FIG. 6 (a). After receiving the preset operation instruction message, the instant messenger group server 11 stores the instant messenger identification contained in the message in the member list of the group identified by the group identification contained in the message, i.e. the instant messenger group server 11 adds the user corresponding to the instant messenger identification as a group member. Preferably, the instant messenger group server 11 also sends a notification to the instant messenger client corresponding to the user. At this time, an example of the prompt information at the user terminal used by the user joining the group just now is illustrated in FIG. 6 (b).

The ways to add a user into an instant messenger group have been elaborated in conjunction with FIG. 1, FIG. 5 and FIG. 6 hereinabove. The transfer progress of an instant message in an instant messenger group will be described in detail with reference to FIG. 1 and FIG. 7 hereinafter. Without loss of generality, suppose that the instant messenger identification corresponding to user 14-1 is abc141@hotmail.com, the instant messenger identification corresponding to user 14-2 is abc142@hotmail.com, both the user 14-1 and the user 14-2 join the instant messenger group identified by group123@xiaoi.com and the instant messenger group server 11 prestores the information shown in table 1. Hereinafter, the transfer process of the group message shown in FIG. 7 will be described in detail by taking the example that the user 14-2 sends instant messages to other members of the instant messenger group identified by group123@xiaoi.com through the instant messenger client used by the user 14-2.

TABLE 1

| instant messenger group | |
|---|---|
| identification | member list |
| group123@xiaoi.com | abc141@hotmail.com; |
| | abc142@hotmail.com; |
| | abc143@hotmail.com |
| group456@xiaoi.com | abc141@hotmail.com; |
| | defgh@hotmail.com; |
| | papaya@163.com |
| group789@xiaoi.com | defgh1@live.cn; |
| | abcd@sina.com |

At first, in step S701, the instant messenger server 11 automatically logs in to the instant messenger server 12 as an instant messenger client, using each of the group identifications as an instant messenger identification.

Then, in step S702, the instant messenger group server 11 receives an instant message which comes from the instant messenger client used by the user 14-2 and is forwarded by the instant messenger server 12. The instant message contains the instant messenger identification corresponding to the instant messenger client, namely the instant messenger identification of the user 14-2 abc142@hotmail.com; and the group identification associated with the instant messenger identification, namely group123@xiaoi.com.

After that, in step S703, the instant messenger group server 11 determines the instant messenger identifications of other members of the group identified by the group identification according to the instant messenger identification of the user 14-2 and the associated group identification contained in the instant message received in step 703. For example, for the case shown in table 1, the instant messenger group server 11 determines that the users identified by abc141@hotmail.com and abs143@hotmail.com and the user 14-2 belong to the same group identified by group123@xiaoi.com.

Finally, in step S704, the instant messenger group server 11 forwards the instant message to the instant messenger clients corresponding to the instant messenger identifications of other members of the group via the instant messenger server 12. For example, for the case shown in table 1, the instant messenger group server 11 sends the instant message to the instant messenger clients corresponding to abc141@hotmail.com and abc143@hotmail.com respectively.

Preferably, in some cases, before step S704, the instant messenger group server 11 can also determine whether the instant message identification is the instant messenger identification of a member of the group identified by the group identification according to the group identification and the instant messenger identification contained in the instant message. Still continuing with the above example, the instant messenger group server 11 can determine whether the user identified by abc142@hotmail.com is a member of the group identified by group123@xiaoi.com according to the information stored in table 1.

If the instant messenger identification in the instant message is the instant messenger identification of a member of the group identified by the group identification, then in step S704, the instant messenger group server 11 forwards the instant message to the instant messenger clients corresponding to the instant messenger identifications of other members of the group identified by the group identification in the instant message via the instant messenger server 12 respectively.

Since the instant messenger group server 11 of the present invention is independent of the instant messenger server 12, for the instant messenger server 12, it does not know the existence of the instant messenger group at all. All of the instant messages are forwarded by the instant messenger server 12, and some of the instant messages in the group are functional instructions, e.g. instructions with management functions. Therefore the instant messenger group server 11 needs to discriminate the received instant messages coming from the instant messenger clients.

For the process shown in FIG. 7, before step S704, the instant messenger group server 11 determines whether an instant message coming from an instant messenger client is a preset operation instruction. If the instant message is not a preset operation instruction message, then step S704 will be performed to send the instant message to the instant messenger clients corresponding to the instant messenger identifications of other members of the group via the instant messenger server 12 respectively.

If the instant messenger group server 11 determines that the instant message from the instant messenger client is a preset operation instruction, then corresponding operations will be performed and the operation results will be sent to the instant messenger client sending the preset operation instruction or to the instant messenger clients corresponding to the instant messenger identifications of all members or partial members of the instant messenger group identified by the group identification contained in the preset operation instruction message.

Preferably, before performing corresponding operations according to the preset operation instruction, the instant messenger group server 11 can also determine whether the user identified by the instant messenger identification is authorized to send the operation instruction according to the user's instant messenger identification contained in the preset operation instruction. If the user is authorized to send the operation instruction, then it performs the corresponding operations and returns the operation results to the instant messenger client used by the user.

After receiving an instant message coming from an instant messenger client, the instant messenger group server 11 first determines whether this message is a preset operation instruction; if it is, then the instant messenger group server 11 determines whether the preset operation instruction is an operation instruction indicating to quit the group; if it is, then the following operations will be performed: according to the instant messenger identification and its associated group identification contained in the operation instruction indicating to quit the group, the instant messenger group server 12 deletes the instant messenger identification from the member list of the group identified by the group identification and sends a notification to the instant messenger server 12. The notification serves to notify the instant messenger server 12 to delete the instant messenger identification from the friend list of the group identified by the group identification.

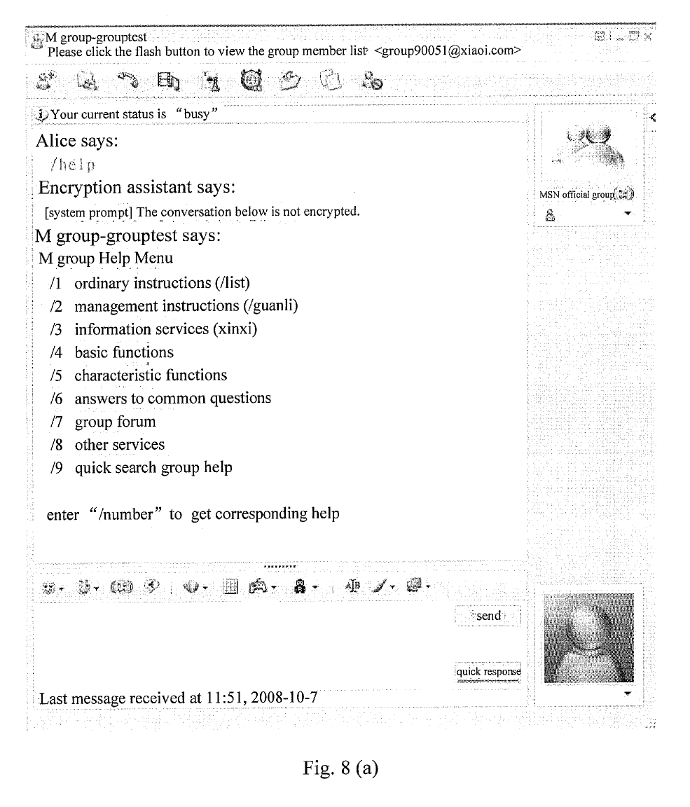

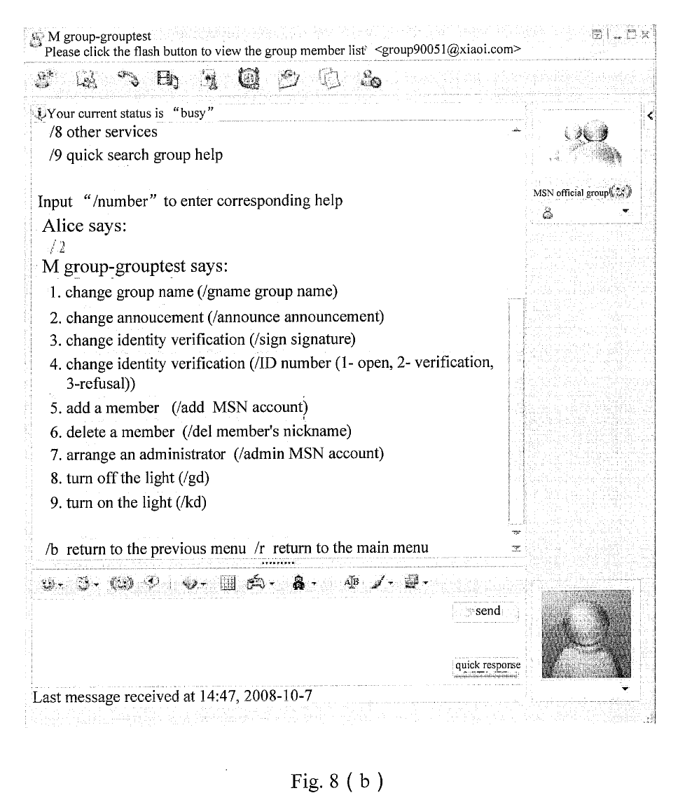

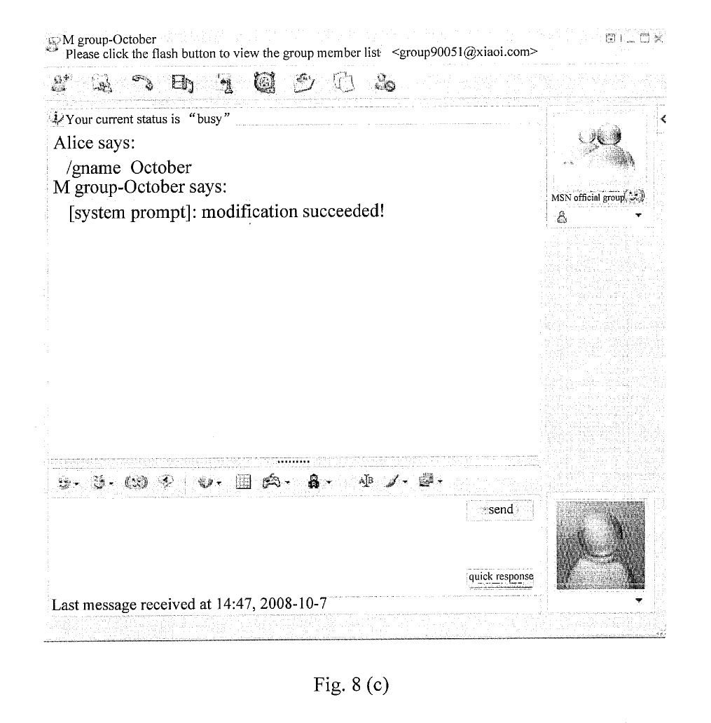

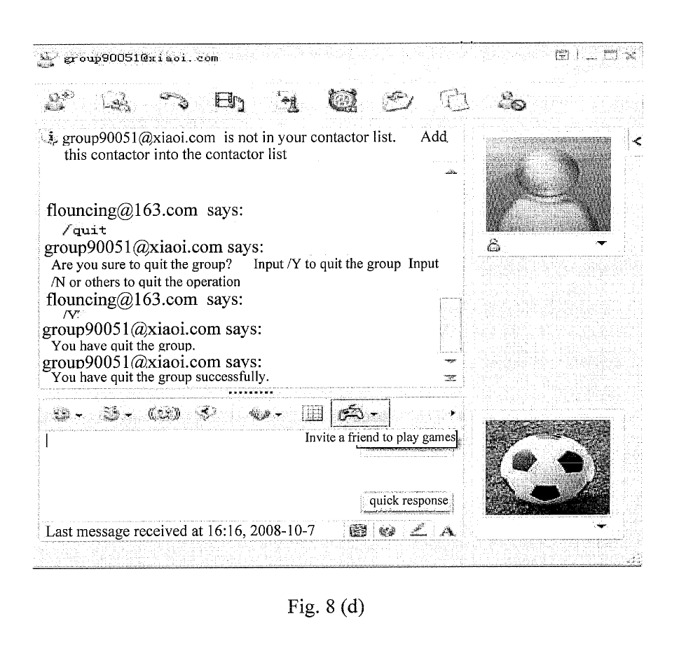

For example, in the MSN group shown in FIG. 8 (a), it is specified that an instant message beginning with “/” is a preset operation instruction, e.g. if a group member user inputs “/help” in the dialogue window of the MSN group, then the instant messenger group server 11 sends the help information, as shown in FIG. 8 (a), to the instant messenger client corresponding to the user and displays the help information in the dialogue window; then the group member user inputs an instruction indicating to obtain the management instruction information in the dialogue window, e.g. “/2” or “/guanli”, and the instant messenger group server 11 sends the management instruction information, as shown in FIG. 8 (b), to the instant messenger client corresponding to the user and displays the management instruction information in the dialogue window; after that, the group member user inputs a preset operation instruction indicating to change the group name in the dialogue window, e.g. “/gname October”, and the instant messenger group server 11 changes the group name, sends the response information, as shown in FIG. 8 (c), to the instant messenger client corresponding to the user and displays the response information in the dialogue window, and at the same time, the group name at the top left of the dialogue window changes accordingly from “M group- grouptest” to “M group- October”.

For another example, if the user inputs an operation instruction indicating to quit the MSN group in the group dialogue window, e.g. “/quit”, then after receiving the operation instruction, the instant messenger group server 11 sends a prompt message indicating the user to decide whether to quit the group or not, as shown in FIG. 8 (d), to the instant messenger client used by the user. If the user decides to quit the group, then the instant messenger group server 11 deletes the instant messenger identification of the user from the member list of the group identified by the corresponding group identification and sends a notification to the MSN server to notify the MSN server to delete the instant messenger identification from the friend list of the group identified by the group identification.

For another example, if the user inputs an operation instruction indicating to inquire all the members of the MSN group in the group dialogue window, e.g. “/All”, then after receiving the operation instruction, the instant messenger group server 11 returns the nicknames and/or the instant messenger identifications of all the members of the group to the user performing the inquiry and displays them in the group dialogue window.

As shown in FIG. 8 (a) to FIG. 8 (d), a preset operation instruction can fulfill many functions including basic functions, management functions and characteristic functions, among which, the management functions are intended for the members having the management authority. For example, as to changing the group name mentioned above, only the users having the management authority can change the group name, i.e. only the users having the management authority can send operation instruction indicating to change the group name. If a user who doesn't have the management authority sends an operation instruction indicating to change the group name, the instant messenger group server 11 won't execute the operation of changing the group name. Preferably, the instant messenger group server 11 sets the user creating a group as the group master who has the highest management authority; the group master can also grant the authority to other users to execute partial management operations. At this time, the information, as shown in table 2, is stored in the instant messenger group server 11. As compared with table 1, the authority attribute of each user is added into table 2.

TABLE 2

| instant messenger group | | |
|---|---|---|
| identification | member list | member attribute |
| group123@xiaoi.com | abc141@hotmail.com | group master |
| | abc143@hotmail.com | general member |
| | abc142@hotmail.com | general member |
| group456@hotmail.com | abc141@hotmail.com | group master |
| | papaya@163.com | general member |
| | defgh@hotmail.com | administrator |
| group789@msnzone.cn | defgh1@live.cn | group master |
| | abcd@sina.com | general member |

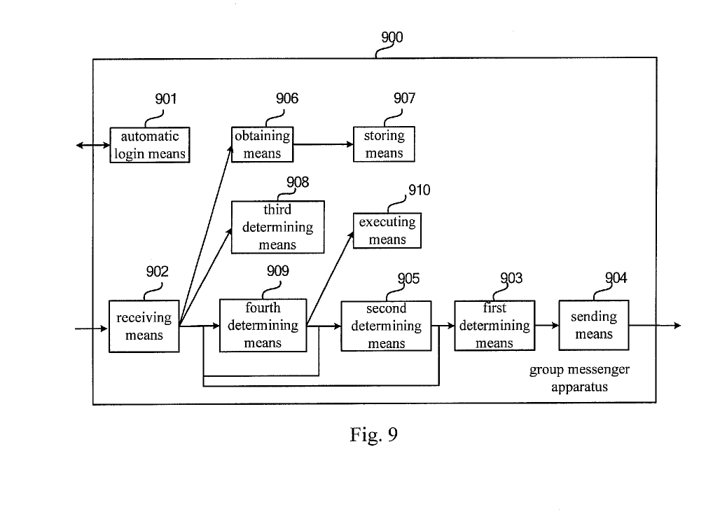

The method flow of the present invention has been described in conjunction with FIG. 1 to FIG. 8 (d) hereinabove. The working process of the group messenger apparatus 900 of the present invention will be explained in detail with reference to FIG. 9 hereinafter.

FIG. 9 illustrates a structural block diagram of the group messaging apparatus 900 according to an embodiment of the present invention. The group messaging apparatus 900 comprises an automatic login means 901, a receiving means 902, a first determining means 903, a sending means 904, a second determining means 905, an obtaining means 906, a storing means 907, a third determining means 908, a fourth determining means 909 and an executing means 910. It should be noted that for simplicity, submeans of many preferred embodiments are shown in FIG. 9, but those skilled in the art should understand that among them, only the automatic login means 901, the receiving means 902, the first determining means 903 and the sending means 904 are necessary means for implementing the present invention and other submeans are all optional means.

In the following part, with reference to FIG. 1, the process that the group messenger apparatus 900 in the instant messenger group server 11 in FIG. 1 realizes instant messaging among multiple members of the instant messenger group will be explained in detail. The process of realizing instant messaging among multiple members of an instant messenger group comprises several major processes including the creation process of the group, the process of joining the group, instant message transfer process in the group, the process of inquiring the group, the process of quitting the group, etc. These major processes will be introduced one by one hereinafter.

Below, the creation process of the group will be firstly elaborated in detail.

At first, the receiving means 902 receives a group creation request sent by the user 14-1 via a user terminal.

The user 14-1 can send a group creation request message via a user terminal in various ways. For example, the user 14-1 sends a group creation request via a user terminal by means of a web browser and a simple example is illustrated in FIG. 3 (a) to FIG. 3 (c). The user 14-1 only needs to open the web page as shown in FIG. 3 (a) through a web browser and click the button 311 “click to create” shown on the web page, and then he can send a group creation request to the instant messenger group server 11.

For another example, the user 14-1 can send a group creation request via the user terminal 13-1 by the instant messenger client. The group creation request contains the instant messenger identification corresponding to the user 14-1 sending the request. That is to say, users who have already used the group can input a command indicating to create a new group in the dialogue window of the group. An example for such case is illustrated in FIG. 4. The case as shown in FIG. 4 takes the MSN group as an example. A user inputs a group creation command, e.g. “/new”, in the dialogue window of the MSN group which the user has joined and clicks the “send” button, namely sending a group creation request to the instant messenger group server 11.

It should be noted that the transfer process of the above mentioned group creation request sent by the user 14-1 through the instant messenger client will be described hereinafter.

Then the first determining means 903 assigns a group identification which has not been used to the newly created group according to the group creation request received by the receiving means 902.

Preferably, in some cases, the instant messenger group server 11 can also ask the user 14-1 to input the name of the instant messenger group, as shown in FIG. 3 (b), and then the first determining means 903 executes the above mentioned determining step.

After that, the automatic login means makes the group server log in to the instant messenger server 12 as an instant messenger client, using the newly created group identification as the instant messenger identification, and the obtaining means 906 obtains the instant messenger identification of the user 14-1 sending the group creation request.

It should be noted that there are various ways for the obtaining means 906 to obtain the instant messenger identification of the user 14-1 sending the group creation request, depending on the ways of sending the group creation request by the user 14-1.

If the user 14-1 sends the group creation request via the user terminal by means of the web browser, the obtaining means 906 obtains the instant messenger identification of the user 14-1 by indicating the user 14-1 to accept the invitation from the user, identified by the newly created group identification, to add the user 14-1 as a friend, as shown in FIG. 3 (c). After a user has clicked the button “add M group” shown in FIG. 3 (c), the obtaining means 906 starts the instant messenger client software of the user terminal 13-1 used by the user 14-1 and indicates the user 14-1 to log in to obtain the instant messenger identification corresponding to the user 14-1. If the user 14-1 has logged in to the instant messenger server 12 through the instant messenger client software, then the obtaining means obtains the instant messenger identification of the user 14-1 directly from the user terminal 13-1.

If the user 14-1 sends the group creation request through the instant messenger client software, then this group creation request contains the instant messenger identification corresponding to the user 14-1 and the obtaining means 906 extracts the instant messenger identification of the user 14-1 from the group creation request.

Finally, according to the instant messenger identification, obtained by the obtaining means 906, of the user 14-1 sending the group creation request, the sending means 904 sends a request, which requests to add the user as the friend of the instant messenger user identified by said newly created group identification, to the instant messenger server 12 and the storing means 907 stores the instant messenger identification of the user 14-1 in the member list of the newly created group.

In some cases, if the user 14-1 sets that other members are allowed to add him as a friend only after the identity verification, then the sending means 904 also needs to send a verification request to the instant messenger client used by the user 14-1. Only after the instant messenger client has sent the verification response to the instant messenger server 12, the instant messenger server 12 adds the instant messenger identification corresponding to the user 14-1 in the friend list of the newly created group.

Above, the group creation process of the group messaging apparatus 900 has been described. The working process of the group messaging apparatus 900 when a user joins an instant messenger group will be elaborated in detail hereinafter.

There are at least two ways that a user joins an instant messenger group: the first way is that a user sends a join request through an instant messenger client; the second way is that the administrator or the group master of the instant messenger group sends a preset operation instruction in the group dialogue window.

In the following part, the above first way will be described in detail.

At first, the receiving means 902 receives the join request which comes from the instant messenger client and is forwarded by the instant messenger server 12. The join request contains the identification of the user 14-2 using the instant messenger client and the group identification of the instant messenger group the instant messenger client requests to join. Of course, the user 14-2 can obtain the instant messenger group identification of the group, which the user 14-2 requests to join, by other means, e.g. the user 13-1 identified by the group identification informs the user 14-2 of the instant messenger group identification directly or indirectly.

Then, the storing means 907 stores the instant messenger identification of the user 14-2 in the member list of the instant messenger group which the user 14-2 requests to join.

Finally, the sending means 904 sends a join response to the instant messenger client used by the user 14-2.

Preferably, in some cases, the third determining means 908 also determines whether the user identified by the instant messenger identification contained in the join request received in step S501 is authorized to join said instant messenger group. Specifically, the third determining means 908 performs the above determining process can by performing an identity verification of the user requesting to join or asking the user to answer some questions.

For MSN's instant messenger users, the above described joining process can be performed by adding contactors. In this case, for the users or the instant messenger server 12, the instant messenger group identification is an ordinary MSN instant messenger identification.

The first way to join a group has been described hereinabove, and the second way will be elaborated hereinafter.

The administrator or the master of the instant messenger group can send an operation instruction indicating to add new users to the current instant messenger group in the group dialogue window, e.g. “/add instant messenger identification” to fulfill the function of adding a new user into the instant messenger group, as shown in FIG. 6 (a). After the receiving the means 902 receives a preset operation instruction, the storing means 907 stores the instant messenger identification contained in the message in the member list of the group identified by the group identification contained in the message, i.e. the instant messenger group server 11 adds the user corresponding to the instant messenger identification as a group member. Preferably, the instant messenger group server 11 also sends a notification to the instant messenger client corresponding to the user. At this time, an example of the prompt information at the user terminal used by the user joining the group just now is illustrated in FIG. 6 (b).

The ways to add a user into an instant messenger group have been explained hereinabove. The transfer progress of an instant message in an instant messenger group will be elucidated in detail.

Without loss of generality, suppose that the instant messenger identification corresponding to user 14-1 is abc141@hotmail.com, the instant messenger identification corresponding to user 14-2 is abc142@hotmail.com, both the user 14-1 and the user 14-2 join the instant messenger group identified by group123@xiaoi.com and the instant messenger group server 11 prestores the information shown in table 1. Hereinafter, the working process of the group messaging apparatus 900 of transferring the group message will be explained in detail by taking the example that the user 14-2 sends instant messages to other members of the instant messenger group identified by group123@xiaoi.com through the instant messenger client used by the user 14-2.

At first, the automatic login means 901 makes the instant messenger server 11 log in to the instant messenger server 12 as an instant messenger client, using each of the group identifications as an instant messenger identification.

Then the receiving means 902 receives an instant message which comes from the instant messenger client used by the user 14-2 and is forwarded by the instant messenger server 12. The instant message contains the instant messenger identification corresponding to the instant messenger client, namely the instant messenger identification of the user 14-2 abc142@hotmail.com; and the group identification associated with the instant messenger identification, namely group123@xiaoi.com.

After that, the first determining means 903 determines the instant messenger identifications of other members of the group identified by the group identification according to the instant messenger identification of the user 14-2 and the associated group identification contained in the instant message received by the receiving means 902. For example, for the case shown in table 1, the instant messenger group server 11 determines that the users identified by abc141@hotmail.com and abs143@hotmail.com and the user 14-2 belong to the same group identified by group123@xiaoi.com.

Finally, the sending means 904 forwards the instant message to the instant messenger clients corresponding to the instant messenger identifications of other members of the group via the instant messenger server 12. For example, for the case shown in table 1, the instant messenger group server 11 sends the instant message to the instant messenger clients corresponding to abc141@hotmail.com and abc143@hotmail.com respectively.

Preferably, in some cases, the second determining means 905 can also determine whether the instant message identification is the instant messenger identification of a member of the group identified by the group identification according to the group identification and the instant messenger identification contained in the instant message. To continue with the above example, the second determining means 905 can determine whether the user identified by abc142@hotmail.com is a member of the group identified by group123@xiaoi.com according to the information stored in table 1.

If the instant messenger identification in the instant message is the instant messenger identification of a member of the group identified by the group identification, then the sending means 904 forwards the instant message to the instant messenger clients corresponding to the instant messenger identifications of other members of the group identified by the group identification in the instant message via the instant messenger server 12 respectively.

Since the instant messenger group server 11 of the present invention is independent of the instant messenger server 12, for the instant messenger server 12, it does not know the existence of the instant messenger group at all. All of the instant messages are forwarded by the instant messenger server 12, and some of the instant messages in the group are functional instructions, e.g. instructions with management functions, therefore the instant messenger group server 11 needs to discriminate the received instant messages coming from the instant messenger clients.

For the above process of transferring instant messages, the fourth determining means 909 determines whether an instant message coming from an instant messenger client is a preset operation instruction. If the instant message is not a preset operation instruction message, then the sending means 904 sends the instant message to the instant messenger clients corresponding to the instant messenger identifications of other members of the group via the instant messenger server 12 respectively.

If the fourth determining means 909 determines that the instant message from the instant messenger client is a preset operation instruction, then the executing means 910 executes corresponding operations and the sending means 904 sends the operation results to the instant messenger client sending the preset operation instruction or to the instant messenger clients corresponding to the instant messenger identifications of all members or partial members of the instant messenger group identified by the group identification contained in the preset operation instruction message.

Preferably, before the executing means 910 executes corresponding operations according to the preset operation instruction, the fourth determining means 909 can also determine whether the user identified by the instant messenger identification is authorized to send the operation instruction according to the user's instant messenger identification contained in the preset operation instruction. If the user is authorized to send the operation instruction, then the executing means 910 executes the corresponding operations and the sending means 904 sends the operation results to the instant messenger client used by the user.

After the receiving means 902 receives an instant message coming from an instant messenger client, the fourth determining means 909 first determines whether this message is a preset operation instruction; if it is, then the fourth determining means 909 determines whether the preset operation instruction is an operation instruction indicating to quit the group; if it is, then the executing means 910 executes the following operations: according to the instant messenger identification and its associated group identification contained in the operation instruction indicating to quit the group, the instant messenger group server 12 deletes the instant messenger identification from the member list of the group identified by the group identification and sends a notification to the instant messenger server 12. The notification serves to notify the instant messenger server 12 to delete the instant messenger identification from the friend list of the group identified by the group identification.

For example, in the MSN group shown in FIG. 8 (a), it is specified that an instant message beginning with “/” is a preset operation instruction, e.g. if a group member user inputs “/help” in the dialogue window of the MSN group, then the group messaging apparatus 900 sends the help information, as shown in FIG. 8 (a), to the instant messenger client corresponding to the user and displays the help information in the dialogue window; then the group member user inputs an instruction indicating to obtain the management instruction information in the dialogue window, e.g. “/2” or “/guanli”, and the group messaging apparatus 900 sends the management instruction information, as shown in FIG. 8 (b), to the instant messenger client corresponding to the user and displays the management instruction information in the dialogue window; after that, the group member user inputs a preset operation instruction indicating to change the group name in the dialogue window, e.g. “/gname October”, and the group messaging means 900 changes the group name, sends the response information, as shown in FIG. 8 (c), to the instant messenger client corresponding to the user and displays the response information in the dialogue window, and at the same time, the group name at the top left of the dialogue window changes accordingly from “M group- grouptest” to “M group- October”.

For another example, if the user inputs an operation instruction indicating to quit the MSN group in the group dialogue window, e.g. “/quit”, then after receiving the operation instruction, the group messaging apparatus 900 sends a prompt message indicating the user to decide whether to quit the group or not, as shown in FIG. 8 (d), to the instant messenger client used by the user. If the user decides to quit the group, then the instant messenger group server 11 deletes the instant messenger identification of the user from the member list of the group identified by the corresponding group identification and sends a notification to the MSN server to notify the MSN server to delete the instant messenger identification from the friend list of the group identified by the group identification.

For another example, if the user inputs an operation instruction indicating to inquire all the members of the MSN group in the group dialogue window, e.g. “/All”, then after receiving the operation instruction, the group messaging apparatus 900 returns the nicknames and/or the instant messenger identifications of all the members of the group to the user performing the inquiry and displays them in the group dialogue window.

As shown in FIG. 8 (a) to FIG. 8 (d), a preset operation instruction can fulfill many functions including basic functions, management functions and characteristic functions. Among the functions, the management functions are directed to the members having the management authority. For example, as to changing the group name mentioned above, only the users having the management authority can change the group name, i.e. only the users having the management authority can send operation instruction indicating to change the group name. If a user who doesn't have the management authority sends an operation instruction indicating to change the group name, the group messaging apparatus 900 won't execute the operation of changing the group name. Preferably, the group messaging apparatus 900 sets the user creating a group as the group master who has the highest management authority; the group master can also grant the authority to other users to execute partial management operations. At this time, the group messaging apparatus 900 stores the information as shown in table 2. As compared with table 1, the authority attribute of each user is added into table 2.

It should be noted that the instant messenger server 12 shown in FIG. 1 involves an arbitrary instant messenger server, e.g. an MSN instant messenger server, a YAHOO!Messenger instant messenger server, a GoogleTalk instant messenger server, a Skype instant messenger server, an AIM instant messenger server, an ICQ instant messenger server, a Jabber instant messenger server, a QQ instant messenger server, a Fetion instant messenger server, an Ali WangWang instant messenger server and a Baidu Hi instant messenger server etc.

Of course, various groups in the instant messenger group server 11 can be groups based on different instant messenger protocols or based on a same instant messenger protocol. For example, group #1 is an instant messenger group based on the MSN instant messenger protocol, and group #2 is an instant messenger group based on the YAHOO!Messenger instant messenger protocol. Preferably, members of an instant messenger group are member users based on a same instant messenger protocol. Of course, members of an instant messenger group can be member users based on multiple instant messenger protocols, the premise of which is that the instant messenger server 12 supports multiple instant messenger protocols.

The embodiments of the present invention have been described hereinabove. It should be remarked that the present invention is not limited to the above mentioned specific embodiments. Those skilled in the art can make various variations and modifications within the scope of the appended claims.

1. A method of realizing instant messaging among a plurality of members of an instant messenger group on an instant messenger group server, wherein said group server is independent of an instant messenger server, at least one group identification and a member list of each group identified by the corresponding group identification being prestored in said group server, each member list storing instant messenger identifications of members of the group identified by the corresponding group identification; and wherein for said instant messenger server, the instant messenger user identified by a group identification is in friend relationship with each member of the group identified by the group identification; the method comprising the steps of:
a. automatically logging in to said instant messenger server as an instant messenger client, using each of said at least one group identification as an instant messenger identification;
b. receiving an instant message sent by an instant messenger client and forwarded by said instant messenger server, said instant message comprising an instant messenger identification corresponding to said instant messenger client and a group identification of the group which the member identified by said instant messenger identification belongs to;
c. determining the instant messenger identifications of other members of the group identified by said group identification according to said instant messenger identification and said group identification contained in said instant message; and
d. sending said instant message to each of the instant messenger clients corresponding to said instant messenger identifications of other members via said instant messenger server respectively.

2. A method according to claim 1, further comprising the following step before the step d:
determining whether said instant messenger identification contained in said instant message is an instant messenger identification of a member of the group identified by said group identification contained in said instant message;
wherein the step d further comprises the following step:
if said instant messenger identification contained in said instant message is an instant messenger identification of a member of the group identified by said group identification contained in said instant message, then sending said instant message to each of the instant messenger clients corresponding to said instant messenger identifications of the other members via said instant messenger server respectively.

3. A method according to claim 1, further comprising the following steps:
i. receiving a group creation request sent by a user via a user terminal;
ii. assigning a group identification which has not been used to the newly created group in response to said group creation request;
iii. logging in to said instant messenger server as an instant messenger client by using said group identification assigned to the newly created group as an instant messenger identification and obtaining instant messenger identification of said user sending said group creation request;
iv. sending a request to said messenger server to add said user as a friend of the user identified by the group identification according to said instant messenger identification of said user sending said group creation request, and storing said instant messenger identification of said user in the member list of said newly created group.

4. A method according to claim 3, wherein the step i comprises the following step:
receiving said group creation request sent by said user via said user terminal by means of a browser;
the way of obtaining said instant messenger identification of said user sending said group creation request in the step iii comprising:
obtaining said instant messenger identification of said user sending said group creation request by indicating said user to run the instant messenger client software and to log in.

5. A method according to claim 3, wherein the step i comprises the following step:
receiving said group creation request sent by said user via said user terminal by means of an instant messenger client, said group creation request comprising the instant messenger identification of said user;
the way of obtaining said instant messenger identification of said user sending said group creation request in the step iii comprising:
extracting said instant messenger identification of said user from said group creation request.

6. A method according to claim 3, further comprising the following steps:
A. receiving a group join request sent by an instant messenger client and forwarded by said instant messenger server, said group join request comprising the instant messenger identification of the user using said instant messenger client and the group identification of the instant messenger group which said user requests to join;
C. storing said instant messenger identification contained in said group join request in the member list of the group identified by said group identification contained in said group join request;
D. sending a group join response to said instant messenger client sending said group join request.

7. A method according to claim 6, further comprising the following step:
B. determining whether said user identified by said instant messenger identification contained in the group join request is authorized to join the group;
the step C further comprising the following step:
if said user is authorized to join the group, storing the instant messenger identification of said user in the member list of said group.

8. A method according to claim 1, further comprising the following step:
determining whether said instant message sent by said instant messenger client is a preset operation instruction;
the step d further comprising the following step:
if said instant message is not a preset operation instruction, then sending said instant message to each of the instant messenger clients corresponding to said instant messenger identifications of other members via said instant messenger server respectively.

9. A method according to claim 8, further comprising the following step:
P. if said instant message is a preset operation instruction, then executing corresponding operations and sending the execution results to said instant messenger client sending said preset operation instruction or to instant messenger clients corresponding to instant messenger identifications of all or partial members of the group identified by said group identification contained in said preset operation instruction.

10. A method according to claim 9, further comprising the following steps:
determining whether said user identified by said instant messenger identification contained in said operation instruction is authorized to send said operation instruction;
executing the step P if said user is authorized to send said operation instruction.

11. A method according to claim 9, further comprising the following step:
determining whether said preset operation instruction is an instruction indicating quitting the group;
wherein if said preset operation instruction is an instruction indicating quitting the group, said corresponding operations in the step P comprise the following step:
deleting said instant messenger identification contained in said preset operation instruction from the member list of the group identified by said group identification contained in said preset operation instruction, and sending a notification to said messenger server, the notification being configured to notify said messenger server to delete said instant messenger identification from the friend list of the user identified by said group identification.

12. A method according to claim 1, wherein the instant messenger server comprises any of the following items:
an MSN instant messenger server;
a YAHOO!Messenger instant messenger server;
a GoogleTalk instant messenger server;
a Skype instant messenger server;
an AIM instant messenger server;
an ICQ instant messenger server;
a Jabber instant messenger server;
a QQ instant messenger server;
a Fetion instant messenger server;
an Ali WangWang instant messenger server;
a Baidu Hi instant messenger server.

13. A method according to claim 1, wherein all members of an instant messenger group use the same instant messenger protocol.

14. A group messaging apparatus for realizing instant messaging among a plurality of members of an instant messenger group by an instant messenger group server, wherein said group server is independent of an instant messenger server, at least one group identification and a member list of each group identified by the corresponding group identification being prestored in said group server, each member list storing instant messenger identifications of members of the group identified by the corresponding group identification; and wherein for said instant messenger server, the instant messenger user identified by a group identification is in friend relationship with each member of the group identified by the group identification, the group messaging apparatus comprising:
an automatic login means configured to log in to said instant messenger server as an instant messenger client using each of said at least one group identification as an instant messenger identification;
a receiving means configured to receive an instant message sent by an instant messenger client and forwarded by said messenger server, said instant message containing an instant messenger identification corresponding to said instant messenger client and a group identification of the group which the member identified by said instant messenger identification belongs to;
a first determining means configured to determine the instant messenger identifications of other members of the group identified by said group identification according to said instant messenger identification and said group identification contained in said instant message; and
a sending means configured to send said instant message respectively to each of the instant messenger clients corresponding to said instant messenger identifications of other members via said instant messenger server.

15. A group messaging apparatus according to claim 14, further comprising:
a second determining means configured to determine whether said instant messenger identification contained in said instant message is an instant messenger identification of a member of the group identified by said group identification contained in said instant message;
wherein said sending means is further configured to:
send said instant message respectively to each of the instant messenger clients corresponding to said instant messenger identifications of the other members via said instant messenger server, if said first determining means determines that said instant messenger identification contained in said instant message is an instant messenger identification of a member of the group identified by said group identification contained in said instant message.

16. A group messaging apparatus according to claim 14, wherein said receiving means is further configured to:
receive a group creation request sent by a user via a user terminal; and
the first determining means is further configured to:
assign a group identification which has not been used to the newly created group in response to said group creation request;
wherein the automatic login means is further configured to:
log in to said instant messenger server as an instant messenger client using said group identification assigned to the newly created group as an instant messenger identification; and
wherein said group messaging apparatus further comprises:
an obtaining means configured to obtain instant messenger identification of said user sending said group creation request; and
said sending means is further configured to:
send a request requesting to add said user as a friend of the user identified by the group identification, to said messenger server according to said instant messenger identification of said user sending said group creation request;
wherein the group messaging apparatus further comprises:
a storing means configured to store said instant messenger identification of said user in the member list of said newly created group.

17. A group messaging apparatus according to claim 16, wherein said receiving means is further configured to:
receive said group creation request sent by said user via said user terminal by means of a browser; and
said obtaining means is further configured to:
obtain said instant messenger identification of said user sending said group creation request by indicating said user to run the instant messenger client software and to log in.

18. A group messaging apparatus according to claim 16, wherein said receiving means is further configured to:
receive said group creation request sent by said user via said user terminal by means of an instant messenger client, said group creation request comprising the instant messenger identification of said user; and
said obtaining means is further configured to:
extract said instant messenger identification of said user from said group creation request.

19. A group messaging apparatus according to claim 16, wherein said receiving means is further configured to:
receive a group join request sent by an instant messenger client and forwarded by said instant messenger server, said group join request comprising the instant messenger identification of the user using said instant messenger client and the group identification of the instant messenger group which said user requests to join;
wherein said storing means is further configured to:
store said instant messenger identification contained in said group join request in the member list of the group identified by said group identification contained in said group join request; and
wherein said sending is further configured to:
send a group join response to said instant messenger client sending said group join request.

20. A group messaging apparatus according to claim 19, further comprising:
a third determining means configured to determine whether said user identified by said instant messenger identification contained in the group join request is authorized to join the group;
wherein said storing means is further configured to the instant messenger identification of said user in the member list of said group if said user is authorized to join the group .

21. A group messaging apparatus according to claim 14, further comprising:
a fourth determining means configured to determine whether said instant message sent by said instant messenger client is a preset operation instruction;
wherein said sending means is further configured to:
send said instant message respectively to each of the instant messenger clients corresponding to said instant messenger identifications of other members via said instant messenger server if said instant message is not a preset operation instruction.

22. A group messaging apparatus according to claim 21, further comprising:
an executing means configured to execute corresponding operations, if said instant message is a preset operation instruction;
wherein said sending means is further configured to:
send the execution results to said instant messenger client sending said preset operation instruction or to instant messenger clients corresponding to instant messenger identifications of all or partial members of the group identified by said group identification contained in said preset operation instruction.

23. A group messaging apparatus according to claim 22, wherein said fourth determining means is further configured to:
determine whether said user identified by said instant messenger identification contained in said operation instruction is authorized to send said operation instruction; and
said executing means is further configured to:
execute the corresponding operations if said user is authorized to send said operation instruction.

24. A group messaging apparatus according to claim 22, wherein said fourth determining means is further configured to:
determine whether said preset operation instruction is an instruction indicating quitting the group;
wherein said executing means is further configured to:
delete said instant messenger identification contained in said preset operation instruction from the member list of the group identified by said group identification contained in said preset operation instruction, if said fourth determining means determines that said preset operation instruction is an instruction indicating quitting the group; and
wherein said sending means is further configured to:
send a notification to said messenger server, the notification being configured to notify said messenger server to delete said instant messenger identification from the friend list of the user identified by said group identification.

25. A group messaging apparatus according to claim 14, wherein the instant messenger server comprises any of the following items:
an MSN instant messenger server;
a YAHOO!Messenger instant messenger server;
a GoogleTalk instant messenger server;
a Skype instant messenger server;
an AIM instant messenger server;
an ICQ instant messenger server;
a Jabber instant messenger server;
a QQ instant messenger server;
a Fetion instant messenger server;
an Ali WangWang instant messenger server;
a Baidu Hi instant messenger server.

26. A group messaging apparatus according to claim 14, wherein all members of an instant messenger group use the same instant messenger protocol.

27. A method according to claim 4, further comprising the following steps:
A. receiving a group join request sent by an instant messenger client and forwarded by said instant messenger server, said group join request comprising the instant messenger identification of the user using said instant messenger client and the group identification of the instant messenger group which said user requests to join;
C. storing said instant messenger identification contained in said group join request in the member list of the group identified by said group identification contained in said group join request;
D. sending a group join response to said instant messenger client sending said group join request.

28. A method according to claim 5, further comprising the following steps:
A. receiving a group join request sent by an instant messenger client and forwarded by said instant messenger server, said group join request comprising the instant messenger identification of the user using said instant messenger client and the group identification of the instant messenger group which said user requests to join;
C. storing said instant messenger identification contained in said group join request in the member list of the group identified by said group identification contained in said group join request;
D. sending a group join response to said instant messenger client sending said group join request.

29. A group messaging apparatus according to claim 17, wherein said receiving means is further configured to:
receive a group join request sent by an instant messenger client and forwarded by said instant messenger server, said group join request comprising the instant messenger identification of the user using said instant messenger client and the group identification of the instant messenger group which said user requests to join;
wherein said storing means is further configured to:
store said instant messenger identification contained in said group join request in the member list of the group identified by said group identification contained in said group join request; and
wherein said sending is further configured to:
send a group join response to said instant messenger client sending said group join request.

30. A group messaging apparatus according to claim 18, wherein said receiving means is further configured to:
receive a group join request sent by an instant messenger client and forwarded by said instant messenger server, said group join request comprising the instant messenger identification of the user using said instant messenger client and the group identification of the instant messenger group which said user requests to join;
wherein said storing means is further configured to:
store said instant messenger identification contained in said group join request in the member list of the group identified by said group identification contained in said group join request; and
wherein said sending is further configured to:
send a group join response to said instant messenger client sending said group join request.
